(19) United States
(12) Patent Application Publication
(10) Pub. No.: US 2023/0419424 A1
(43) Pub. Date: Dec. 28, 2023

(54) POWER SUPPLY SYSTEM AND METHOD FOR COLLECTIVE BUILDING

(71) Applicant: Kevinlab Co., Ansan-si (KR)

(72) Inventors: Kyung Hak KIM, Suwon-si (KR); Sung Hwan CHOI, Seoul (KR)

(73) Assignee: Kevinlab Co., Ansan-si (KR)

(21) Appl. No.: 18/342,470

(22) Filed: Jun. 27, 2023

(30) Foreign Application Priority Data
Jun. 28, 2022 (KR) 10-2022-0078831

(51) Int. Cl. G06Q 50/06; H02J 3/00

(52) U.S. Cl. CPC G06Q 50/06; H02J 3/008

(57) ABSTRACT

An aspect of a power supply system for a collective building according to an embodiment of the present disclosure is a system for supplying power to common loads that consume power for common purposes of a large number of households constituting a collective building and to separate loads that consume power for separate purposes of the households, the power supply system including: a new renewable energy facility that produces power that is used by the common loads and the separate loads of the households; and an energy storage system that stores power produced at the new renewable energy facility, in which the power stored in the energy storage system is equally assigned to the households and the power assigned to the households is supplied to at least one of the common loads and the separate loads.

### CROSS REFERENCE TO RELATED APPLICATION

The present application claims priority to Korean Patent Application No. 10-2022-0078831, filed Jun. 28, 2022, the entire contents of which is incorporated herein for all purposes by this reference.

### BACKGROUND OF THE INVENTION

### Field of the Invention

The present disclosure relates to a power supply system and method for a collective building.

### Description of the Related Art

Recently, a ┌Zero Energy Building Certification System┘ is in operation as a certification system for improving energy efficiency of buildings. The ┌Zero Energy Building Certification System┘ requires, as a certification condition, that the energy independence rate that is the ratio of new renewable energy of the energy that is used by buildings is 20% or more.

Meanwhile, a progressive system that increases the power cost in accordance with the usage of power is applied to impose a rate to the commercial power that is supplied by Korea Electric Power Corporation. Further, since production of energy, substantially, power at new renewable energy facilities and use of the produced power do not agree with each other in terms of time, new renewable energy facilities are generally used with an Energy Storage System (ESS) for storing produced power. However, power that is produced at new renewable energy facilities should be supplied to power loads such that the power usage by the power loads does not correspond to a progressive range, but an appropriate technology for this subject has not been proposed. In particular, in collective buildings such as an apartment or an office building, different power usage of the households is not considered, so the power stored in an ESS is not efficiently used.

### PRIOR ART DOCUMENT

### Patent Document

(Patent Document 1) Korean Patent Application No. 2020-0095399 (2020 Jul. 30, Title: METHOD AND APPARATUS FOR SAVING ENERGY OF INDIVIDUAL CONSUMER USING COMMON ENERGY STORAGE SYSTEM)
(Patent Document 2) Korean Patent Application No. 2020-0031090 (2020 Mar. 13, Title: ENERGY STORAGE CLOUD SYSTEM AND ELECTRIC POWER MANAGEMENT METHOD THEREOF)
(Patent Document 1) Korean Patent No. 1805924 (Title: SYSTEM AND METHOD FOR SCHEDULING POWER USAGE IN PICO GRID)

### SUMMARY OF THE INVENTION

The present disclosure has been made in an effort to solve the problems in the related art described above and an objective of the present disclosure is to provide a power supply system and method for a collective building, the system and method being configured to be able to more economically use new renewable energy in consideration of an electricity progressive tax.

In order to achieve the objectives, an aspect of a power supply system for a collective building according to an embodiment of the present disclosure is a system for supplying power to common loads that consume power for common purposes of a large number of households constituting a collective building and to separate loads that consume power for separate purposes of the households, the power supply system including: a new renewable energy facility that produces power that is used by the common loads and the separate loads of the households; and an energy storage system that stores power produced at the new renewable energy facility, in which the power stored in the energy storage system is equally assigned to the households and the power assigned to the households is supplied to at least one of the common loads and the separate loads.

In an aspect of an embodiment of the present disclosure, when it is determined that current month's power consumption of the households will maintain a current range in a progressive system in consideration of pre-stored power consumption patterns of the households and the number of remaining days in the corresponding month, power that the households bear of daily power consumption of the common loads in the power assigned to the households is supplied to the common loads and then remaining power of the power assigned to the households is supplied to the separate loads of the households; and when it is determined that the current month's power consumption of the households will entire an upper range in the progressive system in consideration of the power consumption patterns of the households and the number of remaining days in the corresponding month, the power assigned to the households is supplied to the separate loads of the households and then the remaining power of the power assigned to the households is supplied to the common loads.

In an aspect of an embodiment of the present disclosure, the households include a first household that has used up assigned power and a second household that has remaining power of assigned power, and when it is determined that current month's power consumption of the first household will enter an upper range in a progressive system in consideration of power consumption patterns of the separate loads of the first household and the number of remaining day in the corresponding month, the power assigned to the second household is diverted and supplied to the separate loads of the first household.

In an aspect of an embodiment of the present disclosure, power that the second household bears of daily power consumption of the common loads in consideration of power consumption patterns of the common load and power assigned to the second household that corresponds to an excess of daily power consumption of the separate loads of the second household that is needed for the current month's power consumption of the second household to maintain a current range in the progressive system in consideration of pre-stored power consumption patterns of the separate loads of the second household are diverted to the separate loads of the first household.

In an aspect of an embodiment of the present disclosure, a price for the power diverted to the first households is distributed to the second households in inverse proportion to the usage of the assigned power.

In an aspect of an embodiment of the present disclosure, the power assigned to the households is selectively supplied to at least one of the common loads and the separate loads of the households, depending on selection of householders of the households.

An aspect of a power supply method for a collective building according to an embodiment of the present disclosure is a method of supplying power to common loads for common purposes of a large number of households constituting a collective building and to separate loads for separate purposes of the households, the power supply method including: a power production step in which power is produced by a new renewable energy facility; a power storage step in which the power produced by the new renewable energy facility is stored in an energy storage system; a power assignment step in which the power stored in the energy storage system is equally assigned to the households; and a power supply step in which the power assigned to the households is supplied to at least one of the common loads and the separate loads of the households.

In an aspect of an embodiment of the present disclosure, in the power supply step, when it is determined that current month's power consumption of the households will maintain a current range in a progressive system in consideration of pre-stored power consumption patterns of the households and the number of remaining days in the corresponding month, power that the households bear of daily power consumption of the common loads in the power assigned to the households is supplied to the common loads and then remaining power of the power assigned to the households is supplied to the separate loads of the households; and when it is determined that the current month's power consumption of the households will entire an upper range in the progressive system in consideration of the power consumption patterns of the households and the number of remaining days in the corresponding month, the power assigned to the households is supplied only to the separate loads of the households.

In an aspect of an embodiment of the present disclosure, the households include a first household that has used up assigned power and a second household that has remaining power of assigned power, and, in the power supply step, when it is determined that current month's power consumption of the first household will enter an upper range in a progressive system in consideration of power consumption patterns of the separate loads of the first household and the number of remaining day in the corresponding month, the power assigned to the second household is diverted and supplied to the separate loads of the first household.

In an aspect of an embodiment of the present disclosure, in the power supply step, power that the second household bears of daily power consumption of the common loads in consideration of power consumption patterns of the common load and power assigned to the second household that corresponds to an excess of daily power consumption of the separate loads of the second household that is needed for the current month's power consumption of the second household to maintain a current range in the progressive system in consideration of pre-stored power consumption patterns of the separate loads of the second household are diverted to the separate loads of the first household.

In an aspect of an embodiment of the present disclosure, a price payment step in which a price for the power diverted to the first households in the power supply step is distributed to the second households in inverse proportion to the usage of the assigned power.

According to the power supply system and method for a collective building according to an embodiment of the present disclosure, power produced at a new renewable energy facility and stored in an energy storage system is equally assigned to households and the power assigned to the households is supply to at least one or common loads and separate loads such that the power consumption of the households does not enter an upper range of a progressive system. In particular, in an embodiment of the present disclosure, power assigned to other households is diverted even to households that have used up assigned power such that their current month's power consumption does not enter an upper range in a progressive system. Therefore, according to the present disclosure, it is possible to supply power stored in an energy storage system to common loads and separate loads so that households can use power at a lower cost.

### BRIEF DESCRIPTION OF THE DRAWINGS

FIG. 1 is a configuration diagram schematically showing a power supply system for a collective building according to an embodiment of the present disclosure; and

FIG. 2 is a flowchart showing a power supply method for a collective building according to an embodiment of the present disclosure.

### DETAILED DESCRIPTION OF THE INVENTION

Hereafter, a power supply system for a collective building according to an embodiment of the present disclosure is described in more detail with reference to the accompanying drawings.

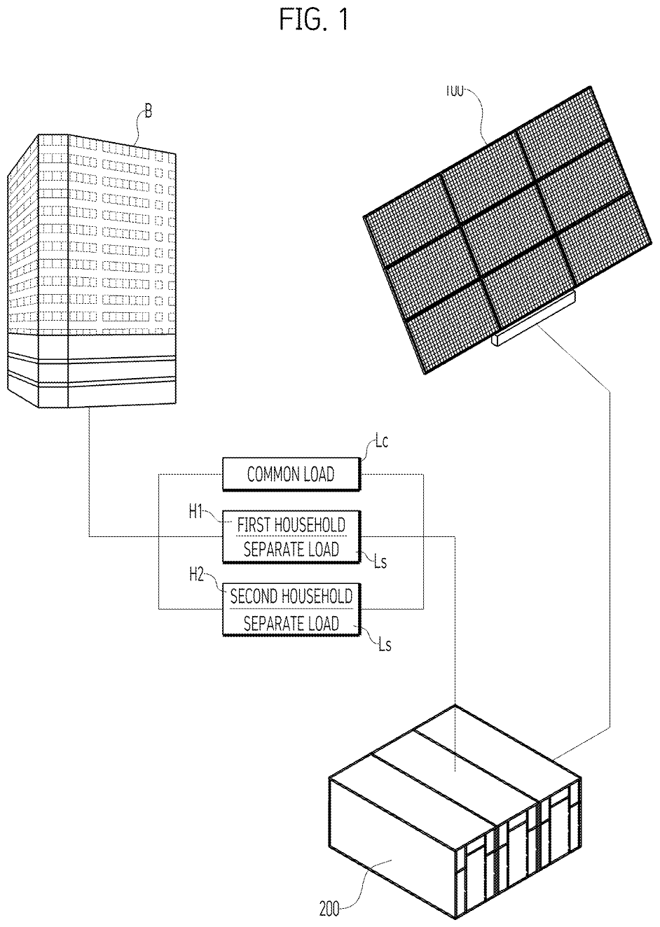

FIG. 1 is a configuration diagram schematically showing a power supply system for a collective building according to an embodiment of the present disclosure.

Referring to FIG. 1, a collective building B to which the this embodiment is applied is composed of a large number of households H1 and H2 and loads that use power in the collective building B can be classified into common loads Lc and separate loads Ls. In this configuration, the common loads Lc are for common purposes of the households H1 and H2 and the separate loads Ls are for individual purposes of the households H1 and H2. Loads that are operated for the common purposes of the household H1 and H2 such as a light in a common space or an elevator or an escalator that is commonly used may be exemplified as the common loads Lc, and loads that are operated for the individual purposes of the households H1 and H2 such as a television, a refrigerator, and a washing machine that are used in each of the households H1 and H2 may be exemplified as the separate loads Ls. A power supply system 1 of the collective building B according to this embodiment is provided to supply power to the common loads Lc and the separate loads Ls and includes a new renewable energy facility 100 and an energy storage system 200.

The new renewable energy facility 100 produces power that is used by the separate loads Ls and the common loads Lc of the households H1 and H2. As the new renewable energy facility 100, well-known facilities such as a solar facility, a daylighting facility, a solar thermal facility, a geothermal energy facility, a wind power facility, a hydroelectric facility, a bio facility, a wood pellet boiler, a waste energy recovery facility, a fuel cell facility, and a hydrothermal energy facility may be used.

Power produced by the new renewable energy facility 100 is stored in the energy storage system 200. The energy storage system 200 may be understood as a battery system in which power is stored.

In this embodiment, the power stored in the energy storage system 200 is equally assigned to the households H1 and H2. Substantially, the power stored in the energy storage system 200 can be assigned to the households H1 and H2 in the unit of preset period, for example, day. For example, when the power stored in the energy storage system 200 is 1,000 KWh and the collective buildings are composed of ten households H1 and H2, 100 KWh can be assigned to each of the households H1 and H2.

Further, the power assigned to the households H1 and H2 of the power stored in the energy storage system 200 is supplied to the common loads Lc or/and the separate loads Ls or/and external loads. In particular, power assigned to the households H1 and H2 can be supplied to the common loads Lc or/and the separate loads Ls under the condition that the current month's power consumption does not enter an upper range in a progressive system. As another example, the power assigned to the households H1 and H2 can be selectively supplied to the common loads Lc and the separate loads Ls of the households H1 and H2, depending on selection of the householders of the households H1 and H2.

In other words, when it is determined that the current month's power consumption of the households H1 and H2 will maintain the current range in a progressive system in consideration of the pre-stored power consumption patterns of the households H1 and H2 and the number of remaining days in the corresponding month, power that the households H1 and H2 bear of the daily power consumption of the common loads Lc in the power assigned to the households H1 and H2 is supplied to the common loads Lc and then the remaining power of the power assigned to the households H1 and H2 can be supplied to the separate loads Ls of the households H1 and H2.

For example, when the daily power consumption of the common loads Lc is 800 kWh, the current month's usage of power provided from a power company of the households H1 and H2 is 150 kWh, the number of remaining days of the current month is 5, and the daily power consumption according to the past power consumption patterns of the households H1 and H2 is expected as 20 kWh, a range of 200 kWh or less that is the current use range can be maintained if the remaining power of 20 kWh excluding 80 kWh supplied to the common loads Lc from the power of 100 kWh assigned to the households H1 and H2 is supplied to the separate loads Ls of the households H1 and H2. Accordingly, in this case, power that the households H1 and H2 bear of the daily power consumption by the common loads Lc in the power assigned to the households H1 and H2 is supplied to the common loads Lc and then the remaining power of the power assigned to the households H1 and H2 is supplied to the separate loads Ls of the households H1 and H2.

On the other hands, when it is determined that the current month's power consumption of the households H1 and H2 will enter an upper range in the progressive system in consideration of the power consumption patterns of the households H1 and H2 and the number of remaining days in the corresponding month, the power assigned to the households H1 and H2 is supplied to the separate loads Ls of the households H1 and H2 and then the remaining power of the power assigned to the households H1 and H2 is supplied to the common loads Lc.

For example, when the daily power consumption of the common loads Lc is 800 kWh, the current month's usage of power provided from a power company of the households H1 and H2 is 150 kWh, the number of remaining days in the current month is 5, and the daily power consumption according to the past power consumption patterns of the households H1 and H2 is expected as 40 kWh, power consumption becomes 250 kWH exceeding 200 kWh that is the current use range and can enter an upper range if the remaining power of 20 kWh excluding 80 kWh supplied to the common loads Lc from the power of 100 kWh assigned to the households H1 and H2 is supplied to the separate loads Ls of the households H1 and H2. Accordingly, in this case, the power assigned to the households H1 and H2 is supplied to the separate loads Ls of the households H1 and h2 and then the remaining power of the power assigned to the households H1 and H2 is supplied to the common loads Lc.

Meanwhile, the households H1 and H2 may be classified into households H1 and H2 that have used up their assigned power and household H1 and H2 that have remaining power of the assigned power. Hereafter, households H1 and H2 that have used up their assigned power of the households H1 and H2 are referred to first households H1 and households H1 and H2 that have remaining power of the assigned power are referred to as second households H2. Accordingly, when the second household H2 uses up assigned power, even the second household H2 will be handled in the same way as the first household H1.

In this embodiment, when it is determined that the current month's power consumption of the first household H1 will enter an upper range in the progressive system in consideration of the pre-stored power consumption patterns of the separate loads Ls of the first household H1 and the number of remaining day in the corresponding month, the power assigned to the second household H2 is diverted and supplied to the separate loads Ls of the first household H1. In other words, in this embodiment, when the current month's power consumption of the first household H1 is expected to enter an upper range in the progressive system, the power assigned to the second household H2 can be diverted to the first household H1.

For example, for the first household H1, the current month's usage of power supplied from a power company is 150 kWh, the number of remaining days in the current month is 5, and daily power consumption that is expected in accordance with the past power consumption pattern of the first household H1 is 20 kWh, the first household H1 enters an upper range of the progressive system when the first household H1 additionally uses power supplied from the power company.

In more detail, power that the second household H2 bears of the daily power consumption of the common loads Lc in consideration of the power consumption patterns of the common load Lc and power assigned to the second household H2 that corresponds to the excess of the daily power consumption of the separate loads Ls of the second household H2 that is needed for the current month's power consumption of the second household H2 to maintain the current range in the progressive system in consideration of the pre-stored power consumption patterns of the separate loads Ls of the second household H2 are diverted to the separate loads Ls of the first household H1. In other words, the power excluding the power that the second household H2 bears for the common loads Lc of the power assigned to the second household H2 and the power required for the second household H2 to maintain the current range in the progressive system can be diverted to the first household H1.

For example, when the daily power consumption of the common loads Lc is 800 kWh, the current month's usage of power provided from a power company of the second household H2 is 150 kWh, the number of remaining days in the current month is 5, and the daily power consumption according to the past power consumption patterns of the second household H2 is expected as 10 kWh, 10 kWh excluding 80 kWh supplied to the common loads Lc and 10 kWh supplied to the separate loads Ls of the second household H2 from 100 kWh assigned to the first household H1 can be diverted to the first household H1.

Further, the price for the power diverted to the first households H1 is distributed to the second households H2 in inverse proportion to the usage of the assigned power. In other words, relatively larger prices are paid to households that have less used the assigned power of the second households H2. For example, the price that the first household H1 pays may be paid in the way that the first household H1 bears some of the maintenance cost that is imposed to the second household H2.

Hereafter, a power supply method for a collective building according to an embodiment of the present disclosure is described in more detail with reference to the accompanying drawings.

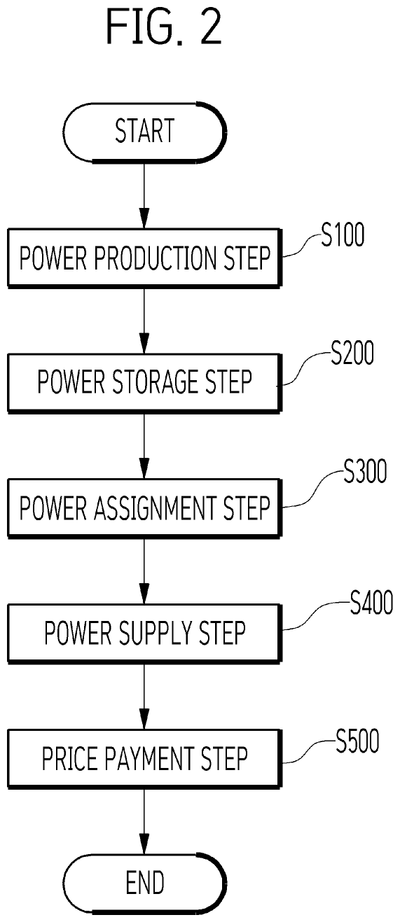

FIG. 2 is a flowchart showing a power supply method for a collective building according to an embodiment of the present disclosure.

Referring to FIG. 2, a power supply method for a collective building according to this embodiment, which is a method of supplying power to common loads for common purposes of many households H1 and H2 constituting a collective building and separate loads Lx for separate purposes of the households H1 and H2, includes a power production step S100, a power storage step S200, a power assignment step S300, a power supply step S400, and a price payment step S500.

In more detail, in the power production step S100, power is produced at a new renewable energy facility 100. Further, in the power storage step S200, the power produced at the new renewable energy facility 100 in the power production step S100 is stored in an energy storage system 200.

Next, in the power assignment step S300, the power stored in the energy storage system 200 in the power storage step S200 is equally assigned to households H1 and H2. Further, in the power supply step S400, power stored in the energy storage system 200 that corresponds to the power assigned to households H1 and H2 in the power assignment step S300 is supplied to common loads Lc or/and separate loads Ls.

As described above, in the power supply step S400, when it is determined that the current month's power consumption of the households H1 and H2 will maintain the current range in a progressive system in consideration of the power consumption patterns of the households H1 and H2 and the number of remaining days in the corresponding month, power that the households H1 and H2 bear of the daily power consumption of the common loads Lc in the power assigned to the households H1 and H2 is supplied to the common loads Lc and then the remaining power of the power assigned to the households H1 and H2 is supplied to the separate loads Ls of the households H1 and H2. Further, in the power supply step S400, when it is determined that the current month's power consumption of the households H1 and H2 will entire an upper range in the progressive system in consideration of the power consumption patterns of the households H1 and H2 and the number of remaining days in the corresponding month, the power assigned to the households H1 and H2 is supplied to the separate loads Ls of the households H1 and H2 and then supplied to the common loads Lc. Accordingly, in this embodiment, the power stored in the energy storage system 200 can be efficiently used such that the households H1 and H2 do not enter an upper range in the progressive system.

In particular, in this embodiment, in the power supply step S400, when it is determined that the current month's power consumption of the first household H1 enters an upper range in the progressive system, the power assigned to the second household H2 is supplied to the separate loads Ls of the first household H1, whereby the first household H1 can be supplied with power from the power company and use the power at a lower cost.

In this case, in the power supply step S400, power that the second household H2 bears of the daily power consumption of the common loads Lc in consideration of the power consumption patterns of the common load Lc and power assigned to the second household H2 that corresponds to the excess of the daily power consumption of the separate loads Ls of the second household H2 that is needed for the current month's power consumption of the second household H2 to maintain the current range in the progressive system in consideration of the pre-stored power consumption patterns of the separate loads Ls of the second household H2 are diverted to the separate loads Ls of the first household H1. That is, in this embodiment, spare power excluding the power that the second household H2 needs is supplied to the first household H1, thereby being able to prevent that a disadvantage is applied to the second household H2.

Finally, in the price payment step S600, the price for the power diverted to the first household H1 in the power supply step S400 is paid to the second household H2. In this embodiment, the price for the power diverted to the first households H1 is distributed to the second households H2 in inverse proportion to the usage of the assigned power, so price can be more fairly paid.

It is apparent that the present disclosure may be changed in various ways by those skilled in the art within the range of the spirit of the present disclosure and the right range of the present disclosure should be construed on the basis of the following claims.

What is claimed is:

1. A power supply system for a collective building that is a system for supplying power to common loads that consume power for common purposes of a large number of households constituting a collective building and to separate loads that consume power for separate purposes of the households, the power supply system comprising:
a new renewable energy facility that produces power that is used by the common loads and the separate load of the households; and
an energy storage system that stores power produced at the new renewable energy facility,
wherein the power stored in the energy storage system (200) is equally assigned to the households and the power assigned to the households is supplied to at least one of the common loads and the separate loads.

2. The power supply system of claim 1, wherein when it is determined that current month's power consumption of the households will maintain a current range in a progressive system in consideration of pre-stored power consumption patterns of the households and the number of remaining days in the corresponding month, power that the households bear of daily power consumption of the common loads in the power assigned to the households is supplied to the common loads and then remaining power of the power assigned to the households is supplied to the separate loads of the households; and
when it is determined that the current month's power consumption of the households will entire an upper range in the progressive system in consideration of the power consumption patterns of the households and the number of remaining days in the corresponding month, the power assigned to the households is supplied to the separate loads of the households and then the remaining power of the power assigned to the households is supplied to the common loads.

3. The power supply system of claim 1, wherein the households include a first household that has used up assigned power and a second household that has remaining power of assigned power, and
when it is determined that current month's power consumption of the first household will enter an upper range in a progressive system in consideration of power consumption patterns of the separate loads of the first household and the number of remaining day in the corresponding month, the power assigned to the second household is diverted and supplied to the separate loads of the first household.

4. The power supply system of claim 3, wherein power that the second household bears of daily power consumption of the common loads in consideration of power consumption patterns of the common load and power assigned to the second household that corresponds to an excess of daily power consumption of the separate loads of the second household that is needed for the current month's power consumption of the second household to maintain a current range in the progressive system in consideration of pre-stored power consumption patterns of the separate loads of the second household are diverted to the separate loads of the first household.

5. The power supply system of claim 2, wherein a price for the power diverted to the first households is distributed to the second households in inverse proportion to the usage of the assigned power.

6. The power supply system of claim 1, wherein the power assigned to the households is selectively supplied to at least one of the common loads and the separate loads of the households, depending on selection of householders of the households.

7. A power supply method for a collective building that is a method of supplying power to common loads for common purposes of a large number of households constituting a collective building (B) and to separate loads for separate purposes of the households, the power supply method comprising:
a power production step in which power is produced by a new renewable energy facility;
a power storage step in which the power produced by the new renewable energy facility is stored in an energy storage system;
a power assignment step in which the power stored in the energy storage system is equally assigned to the households; and
a power supply step in which the power assigned to the households is supplied to at least one of the common loads and the separate loads of the households.

8. The power supply method of claim 7, wherein in the power supply step,
when it is determined that current month's power consumption of the households will maintain a current range in a progressive system in consideration of pre-stored power consumption patterns of the households and the number of remaining days in the corresponding month, power that the households bear of daily power consumption of the common loads in the power assigned to the households is supplied to the common loads and then remaining power of the power assigned to the households is supplied to the separate loads of the households; and
when it is determined that the current month's power consumption of the households will entire an upper range in the progressive system in consideration of the power consumption patterns of the households and the number of remaining days in the corresponding month, the power assigned to the households is supplied only to the separate loads of the households.

9. The power supply method of claim 8, wherein the households include a first household that has used up assigned power and a second household that has remaining power of assigned power, and
in the power supply step, when it is determined that current month's power consumption of the first household will enter an upper range in a progressive system in consideration of power consumption patterns of the separate loads of the first household and the number of remaining day in the corresponding month, the power assigned to the second household is diverted and supplied to the separate loads of the first household.

10. The power supply method of claim 9, wherein in the power supply step, power that the second household bears of daily power consumption of the common loads in consideration of power consumption patterns of the common load and power assigned to the second household that corresponds to an excess of daily power consumption of the separate loads of the second household that is needed for the current month's power consumption of the second household to maintain a current range in the progressive system in consideration of pre-stored power consumption patterns of the separate loads of the second household are diverted to the separate loads of the first household.

11. The power supply method of claim 8, further comprising a price payment step in which a price for the power diverted to the first households in the power supply step is distributed to the second households in inverse proportion to the usage of the assigned power.
